(19) United States
(12) Patent Application Publication
(10) Pub. No.: US 2006/0262560 A1
(43) Pub. Date: Nov. 23, 2006

(54) Flat fluorescent lamp and display device provided with the same

(76) Inventors: Hyoung-Joo Kim, Uiwang-si (KR); Jin-Seob Byun, Seoul (KR); Min-Gyu Kim, Seoul (KR)

Correspondence Address: CANTOR COLBURN, LLP, 55 GRIFFIN ROAD SOUTH, BLOOMFIELD, CT, 06002, US

(21) Appl. No.: 11/496,339

(22) Filed: Jul. 31, 2006

(30) Foreign Application Priority Data
Mar. 8, 2005 (KR) 10-2005-0070957

(51) Int. Cl. F21V 7/04

(52) U.S. Cl. 362/614; 362/613

(57) ABSTRACT

A flat fluorescent lamp includes a lamp body divided into a plurality of discharge spaces and generating light, an electrode formed on ends of the lamp body and a plurality of heat wires unequally disposed within the discharge spaces.

This application claims priority to Korean Patent Application No. 10-2005-0070957 filed on Aug. 3, 2005 and all the benefits accruing therefrom under 35 U.S.C. §119, the entire contents of which are incorporated herein by reference in its entirety.

### BACKGROUND OF THE INVENTION

(a) Field of the Invention

The present invention relates to a flat fluorescent lamp and a display device provided with the same. More particularly, the present invention relates to a flat fluorescent lamp having improved durability and improved stability and a display device provided with the same.

(b) Description of the Related Art

Among various display devices, a liquid crystal display, which has highly improved performance with the down-sizing (reducing the overall size) and the weight reduction due to rapidly developing semiconductor technologies, has become a representative display device.

Since a liquid crystal display has various advantages such as the down-sizing, the weight reduction, and low power consumption, a liquid crystal display has gradually attracted attention as an alternative display for a conventional cathode ray tube (“CRT”). A liquid crystal display has been used as a display device most frequently of information processing devices that need a display device, such as small-sized products like cellular phones, personal digital assistants (“PDAs”), and so on, and middle/large sized products such as monitors, televisions, and so on.

A conventional liquid crystal display is a non-emissive type of display device in which the alignment of liquid crystal molecules is changed by applying a voltage to specifically align liquid crystal molecules and display images using optical characteristic changes, which are caused by the change of the alignment of liquid crystal molecules, such as birefringence, optical rotary power, dichroism and optical scattering.

Since the liquid crystal display uses a non-emissive type of display panel that does not emit light by itself, the liquid crystal display has a backlight assembly for supplying light to a rear surface of the display panel. A large liquid crystal display such as a digital TV is provided with a backlight assembly that uses a plurality of tube-type lamps. However, in this case, many parts are used, so there is a problem in that an assembly process is very complicated. In addition, it is difficult to uniformly supply light to a display panel, so there is a problem in that light uniformity is poor.

It has become very important to realize high luminance and excellent display uniformity in response to an increase in a size of a liquid crystal display. Thus, in order to solve drawbacks of the tube-type lamp, a display device provided with a planar light source unit such as a flat fluorescent lamp is being developed.

However, the planar light source unit has a drawback in that the planar light source unit has a very long initial lighting stabilization time compared to a cold cathode fluorescent lamp (“CCFL”).

In addition, since the planar light source unit uses a discharge gas including mercury, mercury included in the discharge gas may be partially adsorbed if temperature distribution within the planar light source unit is not uniform, so that a phenomenon in which a portion of the planar light source unit brings out a pink color (pinkish phenomenon) may occur.

### BRIEF SUMMARY OF THE INVENTION

An exemplary embodiment provides a flat fluorescent lamp having advantages of reducing initial lighting stabilization time and making the temperature distribution therein uniform so as to reduce or effectively prevent a phenomenon (pinkish phenomenon) in which a portion thereof brings out a pink color, by improving the structure thereof, and a display device provided with the same.

An exemplary embodiment provides a flat fluorescent lamp including a lamp body divided into a plurality of discharge spaces and generating light, an electrode formed on both ends of the lamp body and a plurality of heat wires unequally disposed within the discharge spaces.

In an exemplary embodiment, the lamp body may include a first light source substrate and a second light source substrate arranged opposite to each other and divided into a plurality of regions and the heat wires may be disposed in each of the regions in different numbers.

In an exemplary embodiment, the first light source substrate and the second light source substrate may form a plurality of channel portions forming the discharge space and a plurality of dividing walls partitioning the channel portions and the heat wires may be disposed to adjoin the dividing walls.

In an exemplary embodiment, the plurality of the regions may be partitioned along an arrangement direction of the channel portions, and the number of heat wire disposed to adjoin each of the dividing walls in the respective regions may gradually increase in the arrangement direction of the channel portions.

In an exemplary embodiment, the plurality of regions may include a first region and a second region. The number of heat wires disposed to adjoin each of the dividing walls in the first region may be one and the number of heat wires disposed to adjoin each of the dividing walls in the second region may be at least two.

In an exemplary embodiment, the plurality of the regions may include a first region, a second region, and a third region. The number of heat wires disposed to adjoin each of the dividing walls in the first region may be one, the number of heat wires disposed to adjoin each of the dividing walls in the second region may be two and the number of heat wires disposed to adjoin each of the dividing walls in the third region may be three.

In an exemplary embodiment, one of the heat wires in each of the first and second regions may be disposed to overlap the each of the dividing walls. One of the heat wires in each of the first, second and third regions may be disposed to overlap the each of the dividing walls.

In an exemplary embodiment, two of the heat wires in the second region may be disposed to partially overlap the each of the dividing walls.

In an exemplary embodiment, one of the heat wires in each of the first and second regions may be disposed to overlap one of the dividing walls and two of the heat wires in the second region may be respectively disposed near side ends of the heat wires. One of the heat wires in each of the first, second and third regions may be disposed to overlap one of the dividing walls and two of the heat wires in the third region may be respectively disposed near side ends of the heat wires.

In an exemplary embodiment, respective temperatures of the channel portions may be substantially equal to each other during operation.

In an exemplary embodiment, the channel portion may be formed in an arch shape and the dividing wall may be formed along one direction and the electrode may be formed on an edge of the first and second light source substrates crossing the one direction. The flat fluorescent lamp may further include phosphor layers respectively formed on opposite surfaces of the first and second light source substrates.

In an exemplary embodiment, a reflection layer may be formed on the second light source substrate.

In an exemplary embodiment, the discharge space may be filled with a discharge gas including mercury.

In an exemplary embodiment, the electrode may be an external electrode.

In another exemplary embodiment, a display device includes a panel assembly displaying images, a flat fluorescent lamp supplying light to the panel assembly and a supporting member supporting the panel assembly and the flat fluorescent lamp. The flat fluorescent lamp includes a lamp body divided into a plurality of discharge spaces and generating light, an electrode formed on both ends of the lamp body and a plurality of heat wires unequally disposed within the discharge spaces.

In an exemplary embodiment, the lamp body may include a first light source substrate and a second light source substrate arranged opposite to each other and divided into a plurality of regions, and the heat wires may be disposed in each of the regions in different numbers.

In an exemplary embodiment, the first light source substrate and the second light source substrate may form a plurality of channel portions forming the discharge space and a plurality of dividing walls partitioning the channel portions and the heat wires may be disposed to adjoin the dividing wall.

In an exemplary embodiment, the plurality of regions may be partitioned along an arrangement direction of the channel portions, and the number of heat wires disposed to adjoin each of the dividing walls in the respective regions may gradually increase in the arrangement direction of the channel portions.

In an exemplary embodiment, the plurality of regions may include a first region and a second region. The number of heat wires disposed to adjoin each of the dividing walls in the first region may be one, and the number of heat wires disposed to adjoin each of the dividing walls in the second region may be at least two.

In an exemplary embodiment, the plurality of regions may include a first region, a second region, and a third region. The number of heat wires disposed to adjoin each of the dividing walls in the first region may be one, the number of heat wires disposed to adjoin each of the dividing walls in the second region may be two, and the number of heat wires disposed to adjoin each of the dividing walls in the third region may be three.

In an exemplary embodiment, one of the heat wires in each of the first and second regions may be disposed to overlap the each of the dividing walls. One of the heat wires in each of the first, second and third regions may be disposed to overlap the each of the dividing walls.

In an exemplary embodiment, two of the heat wires in the second region may be disposed to partially overlap the each of the dividing walls.

In an exemplary embodiment, one of the heat wires in each of the first and second regions may be disposed to overlap the each of the dividing walls and two of the heat wires in the second region may be respectively disposed near side ends of the heat wires. One of the heat wires in each of the first, second and third regions may be disposed to overlap the each of the dividing walls and two of the heat wires in the third region may be respectively disposed near side ends of the heat wires.

In an exemplary embodiment, respective temperatures of the channel portions may be substantially equal to each other during operation.

In an exemplary embodiment, the channel portion may be formed in an arch shape, and the dividing wall may be formed along one direction. The electrode may be formed on an edge of the first and second light source substrates crossing the one direction and the flat fluorescent lamp may further include phosphor layers respectively formed on opposite surfaces of the first and second light source substrates.

In an exemplary embodiment, a reflection layer may be formed on the second light source substrate.

In an exemplary embodiment, the discharge space may be filled with a discharge gas including mercury.

In an exemplary embodiment, the electrode may be an external electrode.

In an exemplary embodiment, the display device may further include a prism member and a diffusing member disposed between the flat fluorescent lamp and the panel assembly.

In an exemplary embodiment, the panel assembly may be a liquid crystal panel.

### BRIEF DESCRIPTION OF THE DRAWINGS

FIG. 1 is a perspective view of an exemplary embodiment of a flat fluorescent lamp according to the present invention.

FIG. 2 is a cross-sectional view of the flat fluorescent lamp taken along line II-II in FIG. 1.

FIG. 3 is a cross-sectional view of another exemplary embodiment of a flat fluorescent lamp according to the present invention.

FIG. 4 is a cross-sectional view of another exemplary embodiment of a flat fluorescent lamp according to the present invention.

FIG. 5 is an exploded perspective view of an exemplary embodiment of a display device including the flat fluorescent lamp of FIG. 1.

FIG. 6 is a block diagram of an exemplary embodiment of a panel unit and a driving apparatus thereof of the display device of FIG. 5.

FIG. 7 is an equivalent circuit diagram of an exemplary embodiment of a pixel of the panel assembly of FIG. 6.

### DETAILED DESCRIPTION OF THE INVENTION

A flat fluorescent lamp according to an exemplary embodiment of the present invention and a display device provided with the same will be described hereinafter with reference to the accompanying drawings. An exemplary embodiment of the present invention exemplifies the present invention, and the present invention is not limited thereto. The same reference numerals will be used for the same or similar elements throughout the specification. In the drawings, the size and relative sizes of layers and regions may be exaggerated for clarity.

It will be understood that when an element or layer is referred to as being “on” or “connected to” another element or layer, the element or layer can be directly on or connected to another element or layer or intervening elements or layers. In contrast, when an element is referred to as being “directly on” or “directly connected to” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be described in detail with reference to the accompanying drawings.

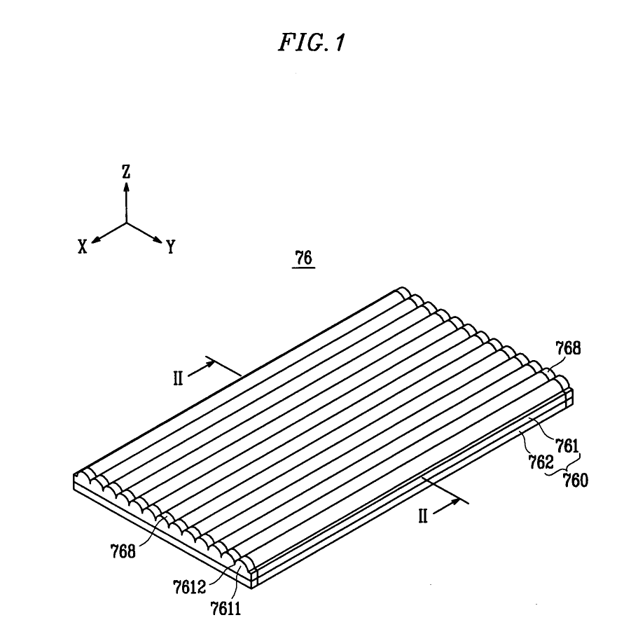

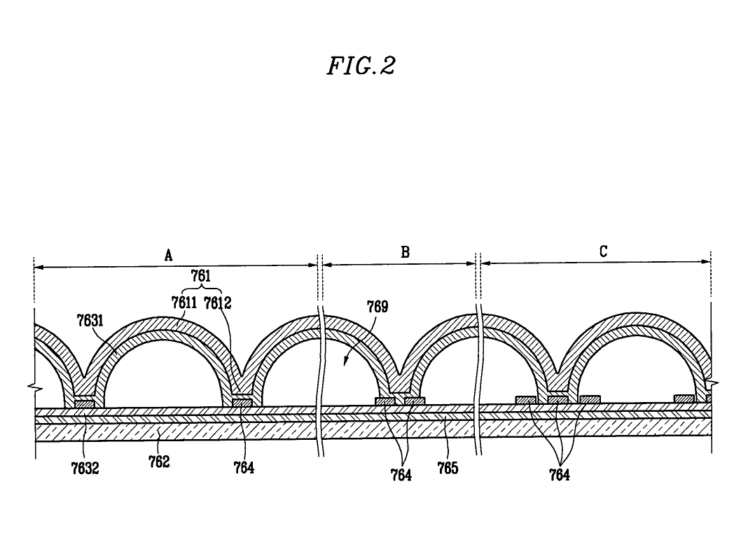

FIG. 1 schematically shows an exemplary embodiment of a flat fluorescent lamp 76 according to the present invention and FIG. 2 is a cross-sectional view of the flat fluorescent lamp 76 taken along line II-II in FIG. 1.

As shown in FIG. 1, the flat fluorescent lamp 76 includes a lamp body 760 divided into a plurality of discharge spaces 769 (shown in FIG. 2) to generate light, an electrode 768 formed on both end portions of the lamp body 760 and heat wires 764 (shown in FIG. 2) unequally disposed across or in the discharge spaces 769. In an exemplary embodiment, an external electrode may be used as the electrode 768.

The lamp body 760 includes a first light source substrate 761 and a second light source substrate 762 arranged opposite to and facing each other so as to form a plurality of channel portions 7611 defining the discharge spaces 769 and a plurality of dividing walls 7612 dividedly partitioning the channel portions 7611. The dividing walls 7612 are portions where the neighboring (adjacent) channel portions 7611 join each other. In exemplary embodiments, a number of channel portions 7611 of the flat fluorescent lamp 76 is not limited to the number shown in FIG. 1, and the number of channel portions 7611 may vary according to the type and size of the flat fluorescent lamp 76.

Referring to FIG. 2, the flat fluorescent lamp 76 will be explained in more detail hereinafter.

In exemplary embodiments, the first light source substrate 761 and the second light source substrate 762 are made of a material including a transparent insulating material such as glass. The first light source substrate 761 and the second light source substrate 762 are divided into a plurality of regions. The dividing wall 7612 is formed by being extended along one direction (hereinafter referred to as a first or longitudinal direction) as a stripe so as to dividedly partition the discharge spaces 769 and the channel portion 7611 is formed in a substantially arch shape in a transverse direction.

The discharge space 769 within the channel portion 7611 is filled with a discharge gas. In exemplary embodiments, the discharge gas may include mercury and/or the discharge is performed by an electrode (not shown). In one exemplary embodiment, the discharge gas may further include neon (Ne) and argon (Ar) along with mercury (Hg).

Fluorescent (phosphor) layers 7631 and 7632 are respectively formed on opposite surfaces of the first light source substrate 761 and the second light source substrate 762 facing each other. The fluorescent layer 7632 may be transparent. In an exemplary embodiment, a reflection layer 765 may be further formed between the second light source substrate 762 and the phosphor layer 7632. The reflection layer 765 causes light generated by the phosphor layers 7631 and 7632 to progress toward the first light source substrate 761. Since the phosphor layer 7632 is transparent, most light emits toward the first light source substrate 761.

In FIG. 2, a plurality of the regions may include a first region A, a second region B and a third region C. In addition, the regions A, B, and C are sequentially divided along an arrangement direction (hereinafter referred to as a second or transverse direction) of the channel portions 7611.

A plurality of heat wires 764 are disposed along the length direction (the first direction) of the dividing wall 7612 to adjoin the dividing wall 7612. The heat wires 764 are disposed such that the number of heat wires 764 adjoining one dividing wall 7612 in the respective regions A, B, and C are different from each other. The heat wires 764 are disposed such that the number of heat wires 764 adjoining one dividing wall 7612 for each of the regions A, B and C gradually increases in the second direction.

As shown in the illustrated embodiment of FIG. 2, the number of heat wires 764 disposed to adjoin one of the dividing walls 7612 in the first region A is one, the number of heat wires 764 disposed to adjoin one of the dividing wall 7612 in the second region B is two and the number of heat wires 764 disposed to adjoin one of the dividing wall 7612 in the third region C is three. In exemplary embodiments, the number of heat wires 764 from region to region may increase in quantity by greater than one.

One of the heat wires 764 is disposed to overlap one of the dividing walls 7612 in the first region A, two of the heat wires 764 are disposed to partially overlap one of the dividing walls 7612 in the second region B. In the third region C, one of the heat wires 764 is disposed to overlap one of the dividing walls 7612 and two of the heat wires 764 are disposed near (adjacent to) side ends of the one of the dividing wall potions 7612. The two heat wires 764 not overlapping and adjacent to the portion of the dividing wall are essentially disposed in the discharge space 769.

Advantageously, by disposing the heat wires 764 within the flat fluorescent lamp 76, an initial lighting stabilization time can be reduced. Furthermore, by disposing the heat wires 764 to overlap the dividing wall 7612 and/or near the dividing wall 7612 rather than disposing the same at substantially the center of the discharge space 769, a shaking phenomenon, which may occur when the heat wire is disposed at the center of the discharge space, can be reduced or effectively prevented.

Still furthermore, by making the temperature distribution within the flat fluorescent lamp 76 substantially uniform by unequally disposing the heat wires 764, a problem (pinkish phenomenon) in which a portion of the flat fluorescent lamp 76 brings out a pink color because of partial adsorption of mercury included in the discharge gas caused by the non-uniform temperature distribution can be reduced or effectively prevented.

The flat fluorescent lamp 76, which may be used in a relatively middle size or large display device such as a monitor and a TV, is uprightly mounted such that a shorter edge thereof is disposed along a vertical direction. Accordingly, by natural transfer of heat generated within the flat fluorescent lamp 76, the temperature in an upper portion of the flat fluorescent lamp 76 becomes relatively high and the temperature in a lower portion of the flat fluorescent lamp 76 becomes relatively low.

In an exemplary embodiment of the present invention, by increasing the number of heat wires 764 toward the lower portion of the flat fluorescent lamp 76 compared to the upper portion thereof, the uniformity of a temperature distribution within the flat fluorescent lamp 76 can be increased. By the unequal disposition of the heat wires 764, the amount of heat generated in the upper portion of the flat fluorescent lamp 76 is relatively small and the amount of heat generated in the lower portion of the flat fluorescent lamp 76 is relatively great, so the temperature distribution of the flat fluorescent lamp 76 becomes substantially uniform. Advantageously, while the flat fluorescent lamp 76 operates, the temperatures of the channel portions 7611 can be maintained to be substantially equal.

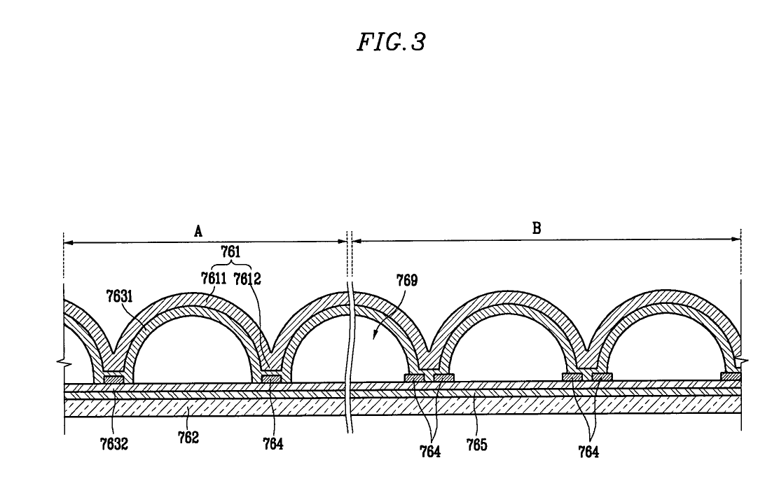

FIG. 3 shows a cross-section of another exemplary embodiment of a flat fluorescent lamp 76 according to the present invention.

As shown in FIG. 3, the flat fluorescent lamp 76 is divided into a plurality of regions, i.e., a first region A and a second region B. The number of heat wires 764 disposed to adjoin one of the dividing walls 7612 in the first region A is one and the number of heat wires 764 disposed to adjoin one of the dividing walls 7612 in the second region B is two.

One of the heat wires 764 is disposed to overlap one of the dividing walls 7612 in the first region A and two of the heat wires 764 are disposed to partially overlap one of the dividing walls 7612 in the second region B.

Advantageously, while the flat fluorescent lamp 76 operates, the temperatures of the channel portions 7611 can be maintained to be substantially equal with a relatively simple structure.

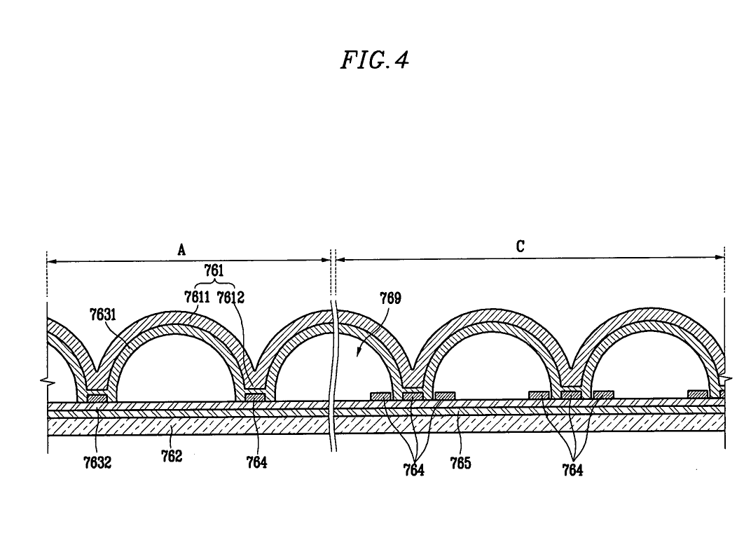

FIG. 4 shows a cross-section of another exemplary embodiment of a flat fluorescent lamp 76 according to the present invention. As shown in FIG. 4, the flat fluorescent lamp 76 is divided into a plurality of regions, i.e., a first region A and a second region C. The number of heat wires 764 disposed to adjoin one of the dividing walls 7612 in the first region A is one and the number of heat wires 764 disposed to adjoin one of the dividing walls 7612 in the second region C is at least three.

One of the heat wires 764 is disposed to overlap one of the dividing walls 7612 in the first region A. In the second region C, one of the heat wires 764 is disposed to overlap one of the dividing walls 7612 and two of the heat wires 764 are disposed near both side ends of the one of the dividing walls 7612, not overlapping the dividing wall 7612.

Advantageously, even when a temperature deviation in the flat fluorescent lamp 76 is substantial, the temperatures of the channel portions 7611 can be maintained to be substantially equal with a relatively simple structure.

In exemplary embodiments, the number of regions and/or the number of heat wires disposed in the respective regions can be variously changed.

In alternative exemplary embodiments, the present invention is not limited to exemplary embodiments as described above and can be realized by various types. The plurality of regions is not limited to being continuously partitioned along the arrangement (second) direction of the channel portion 7611. A circuit portion or parts (not shown) that generate a great amount of heat may be disposed to adjoin the flat fluorescent lamp 76. Heat may be transferred to the flat fluorescent lamp 76 from these parts, so the temperature of a portion of the flat fluorescent lamp 76 may be higher than the temperature of another portion. In addition, within the flat fluorescent lamp 76, a great amount of heat may be generated near the electrode 768 (shown in FIG. 1), so the temperature of a portion near the electrode 768 may be higher than the temperature of another portion. As such, by partitioning the flat fluorescent lamp 76 into a portion that is partially heated to a high temperature by internal and/or external factors and the other portion having a plurality of regions, and/or by disposing the heat wires 764 in the respective regions in different numbers, the overall temperature of the flat fluorescent lamp can be substantially uniform.

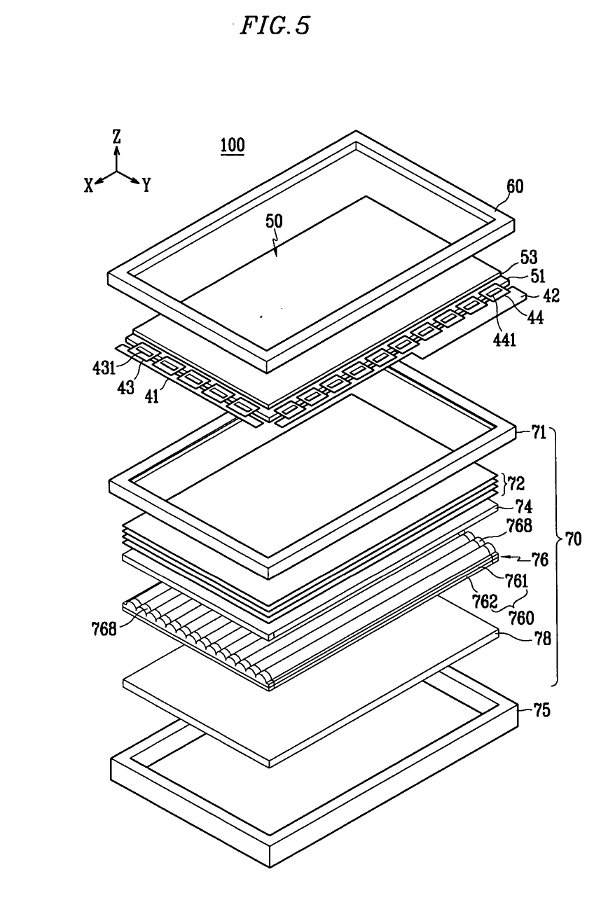

FIG. 5 shows an exemplary embodiment of a display device 100 provided with the flat fluorescent lamp 76 according to various exemplary embodiments of the present invention. Although a liquid crystal panel is shown as an exemplary embodiment of a panel assembly 50 used in the display device 100, this simply exemplifies the present invention, and the present invention is not limited thereto. In alternative exemplary embodiments, a different type of non-emissive type display panel can be used instead of the liquid crystal panel.

As shown in FIG. 5, the display device 100 includes a backlight assembly 70 for supplying light and the panel assembly 50 for receiving the light and displaying images. In addition, the display device 100 may further include supporting members 60, 71, and 75 for fixedly supporting the panel assembly 50 and other parts and/or other necessary parts. The supporting member includes a first supporting member 71 and a second supporting member 75 constituting the backlight assembly 70, and a third supporting member 60 for fixing the panel assembly 50 to the backlight assembly 70.

Although FIG. 5 shows that both the first supporting member 71 and the second supporting member 75 are used, this simply exemplifies the present invention, and the present invention is not limited thereto. In alternative exemplary embodiments, it may be sufficient that one of the first and second supporting members 71 and 75 is used.

The display device 100 includes printed circuit boards (“PCBs”) 41 and 42 for supplying driving signals to the panel assembly 50 and driving IC packages 43 and 44 for electrically connecting the driving PCBs 41 and 42 and the panel assembly 50. In one exemplary embodiment, the driving IC packages 43 and 44 may be formed as a COF (chip on film) or a TCP (tape carrier package). The PCBs include the gate PCB 41 and the data PCB 42. The driving IC packages include the gate driving IC package 43 for connecting the panel assembly 50 and the gate PCB 41 and the data driving IC package 44 for connecting the panel assembly 50 and the data PCB 42.

The backlight assembly 70 includes the flat fluorescent lamp 76 for supplying light, a light guide or prism member 74 and a diffusing member 72 for enhancing the luminance characteristic of light emitted from the flat fluorescent lamp 76, and the first supporting member 71 and the second supporting member 75 for housing and fixedly supporting these parts. The backlight assembly 70 may further include a reflection member 78 disposed at a rear surface of the flat fluorescent lamp 76 for reflecting light. In an exemplary embodiment, if the reflection layer 765 (such as shown in FIG. 2) is formed within the flat fluorescent lamp 76, the reflection member 78 can be omitted.

The prism member 74 causes light emitted from the flat fluorescent lamp 76 to vertically progress to thereby improve luminance. The diffusing member 72 further diffuses light so as to reduce or effectively prevent light from being partially concentrated to form spots on the panel assembly 50 to thereby improve uniformity of light. Although the prism member 74 and the diffusing member 72 are used in order to improve the luminance characteristic of light emitted from the flat fluorescent lamp 76 as illustrated in FIG. 5, a diffuser can be used instead of the prism member 74 according to the type of display device 100.

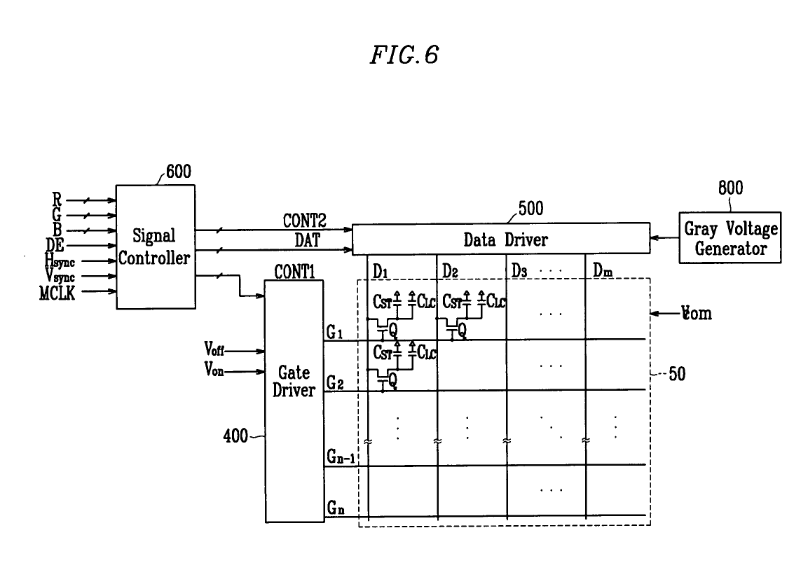

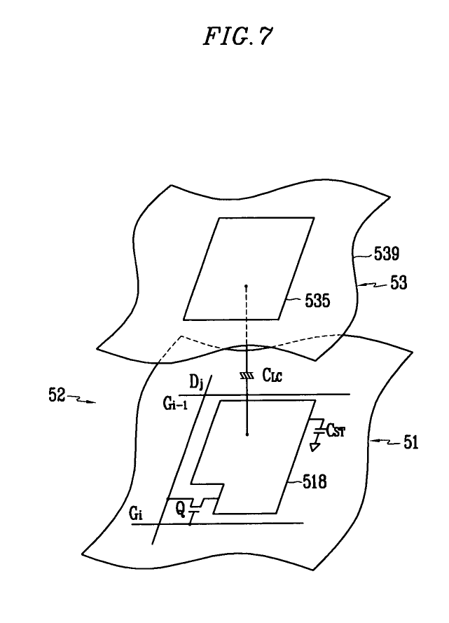

The panel assembly 50 includes a first display panel 51 and a second display panel 53 arranged to face the first display panel 51 with a liquid crystal layer 52 (shown in FIG. 7) interposed therebetween. The first display panel 51 may be considered a rear substrate and the second display panel 53 may be considered a front substrate. The driving IC packages 43 and 44 are connected to the first display panel 51. The gate driving IC package 43 is attached to one edge of the first display panel 51 and the gate driving IC package 43 includes an IC chip 431 constituting a gate driver 400 (shown in FIG. 6). The data driving IC package 44 is attached to another edge (being adjacent to the one edge) of the first display panel 51 and the data driving IC package 44 includes an IC chip 441 constituting a data driver 500 and a gray voltage generator 800 (shown in FIG. 5).

Referring to FIG. 6 and FIG. 7, exemplary embodiments of the panel assembly 50 and an apparatus for driving the same will be explained in detail.

As shown in FIG. 6 and FIG. 7, the first display panel 51 includes a plurality of signal lines G₁ to Gₙ and D₁ to Dₘ. The first and second display panels 51 and 53 are connected to the signal lines G₁ to Gₙ and D₁ to Dₘ, and include a plurality of pixels substantially arranged in a matrix shape.

The signal lines G₁ to Gₙ and D₁ to Dₘ include a plurality of gate lines G₁ to Gₙ for transmitting gate signals (also referred to as scanning signals) and data lines D₁ to Dₘ for transmitting data signals. The gate lines G₁ to Gₙ substantially extend in a row direction to be substantially parallel to one another and the data lines D₁ to Dₘ substantially extend in a column direction to be substantially parallel to one another.

Each pixel includes a switching element Q connected to the signal lines G₁ to Gₙ and D₁ to Dₘ, and a liquid crystal capacitor C_{LC} and a storage capacitor C_{ST} each connected to the switching element Q. In exemplary embodiments, the storage capacitor C_{ST} can be omitted.

In exemplary embodiments, a thin film transistor may be an example of the switching element Q and formed on the first display panel 51. The thin film transistor may be a three terminal element whereby a control terminal and an input terminal thereof are connected to the gate lines G₁ to Gₙ and the data lines D₁ to Dₘ, respectively, and an output terminal thereof is connected to the liquid crystal capacitor C_{LC} and the storage capacitor C_{ST}.

The signal controller 600 controls operations of the gate driver 400 and the data driver 500. The gate driver 400 applies gate signals including a combination of a gate-on voltage Von and a gate-off voltage Voff to the gate lines G₁ to Gₙ The data driver 500 applies data voltages to the data lines D₁ to Dₘ. The gray voltage generator 800 generates two sets of gray voltages related to transmittance of the pixel and supplies the generated gray voltages to the data driver 500 as data voltages. One of the two sets of gray voltages has a positive value with respect to the common voltage Vcom and the other of the two set of gray voltages has a negative value with respect to the common voltage Vcom.

As shown in FIG. 7, the liquid crystal capacitor C_{LC} includes two terminals, one being of a pixel electrode 518 of the first display panel 51 and the other being a common electrode 539 of the second display panel 53. The liquid crystal layer 52 between the two electrodes 518 and 539 serves as a dielectric material. The pixel electrode 518 is connected to the switching element Q. The common electrode 539 may be formed on the entire surface of the second display panel 53 and a common voltage Vcom is applied to the common electrode 539. In an alternative exemplary embodiment, the common electrode 539 may be provided on the first display panel 51. One of the two electrodes 518 and 539 may be formed in a linear or bar shape. A color filter 535, which endows color to transmitted light, is formed on the second display panel 53. In an alternative exemplary embodiment, the color filter 535 may be formed on the first display panel 51.

The storage capacitor C_{ST}, which assists the liquid crystal capacitor C_{LC}, has a separate signal line (not shown) provided on the first display panel 51 and the pixel electrode 518 to overlap each other with an insulator therebetween. A fixed voltage such as the common voltage Vcom is applied to the separate signal line. In an alternative exemplary embodiment, the storage capacitor C_{ST} may be formed by the pixel electrode 518 and/or the overlying previous gate lines G₁ to Gₙ may be arranged to overlap each other through an insulator.

A polarizer (not shown), which polarizes light, may be attached to an outer surface of at least one of the two substrates 51 and 53 of the panel assembly 50.

If the thin film transistor, which is a switching element, is turned on, an electric field is generated between the pixel electrode 518 and the common electrode 539. The alignment angle of liquid crystal of the liquid crystal layer 52 between the first display panel 51 and the second display panel 53 varies depending on the electric field, and a change in the alignment angle of the liquid crystal causes a change in transmittance of light so that desired images are realized.

While this invention has been described in connection with what is considered to be practical exemplary embodiments, it is to be understood that the invention is not limited to the disclosed embodiments, but, on the contrary, is intended to cover various modifications and equivalent arrangements included within the spirit and scope of the appended claims.

In the illustrated exemplary embodiments described above, the durability and the stability of the flat fluorescent lamp can be improved.

By disposing the heat wire within the flat fluorescent lamp, the initial lighting stabilization time can be reduced.

In addition, by disposing the heat wires in different positions in different numbers, the temperature distribution within the flat fluorescent lamp can be uniform. While the flat fluorescent lamp operates, temperatures of channel portions can be maintained to be substantially equal.

Advantageously, an undesireable occurrence (pinkish phenomenon) in which a portion of the flat fluorescent lamp 76 emits a pink color because of the partial adsorption of mercury included in the discharge gas caused by the non-uniform temperature distribution can be reduced or effectively prevented.

In an exemplary embodiment, a display device provided with the flat fluorescent lamp can be provided.

What is claimed is:

1. A flat fluorescent lamp comprising:
a lamp body divided into a plurality of discharge spaces and generating light;
an electrode formed on ends of the lamp body; and
a plurality of heat wires unequally disposed within the discharge spaces.

2. The flat fluorescent lamp of claim 1, wherein:
the lamp body comprises a first light source substrate and a second light source substrate arranged opposite to each other and divided into a plurality of regions; and
the heat wires are disposed in each of the regions in different numbers.

3. The flat fluorescent lamp of claim 2, wherein:
the first light source substrate and the second light source substrate form a plurality of channel portions forming the discharge spaces and a plurality of dividing walls partitioning the channel portions; and
the heat wires are disposed to adjoin the dividing wall.

4. The flat fluorescent lamp of claim 3, wherein:
the plurality of regions are partitioned along an arrangement direction of the channel portions; and
the number of heat wires disposed to adjoin each of the dividing walls in the respective regions gradually increases in the arrangement direction of the channel portions.

5. The flat fluorescent lamp of claim 3, wherein:
the plurality of regions comprise a first region and a second region; and
the number of heat wires disposed to adjoin each of the dividing walls in the first region is one and the number of heat wires disposed to adjoin each of the dividing walls in the second region is at least two.

6. The flat fluorescent lamp of claim 3, wherein:
the plurality of regions comprise a first region, a second region, and a third region; and
the number of heat wires disposed to adjoin each of the dividing walls in the first region is one, the number of heat wires disposed to adjoin each of the dividing walls in the second region is two, and the number of heat wires disposed to adjoin each of the dividing walls in the third region is three.

7. The flat fluorescent lamp of claim 5, wherein one of the heat wires in each of the first and second regions is disposed to overlap the each of the dividing walls.

8. The flat fluorescent lamp of claim 6, wherein one of the heat wires in each of the first, second and third regions is disposed to overlap the each of the dividing walls.

9. The flat fluorescent lamp of claim 5, wherein two of the heat wires in the second region are disposed to partially overlap the each of the dividing walls.

10. The flat fluorescent lamp of claim 5, wherein one of the heat wires in the second region is disposed to partially overlap the each of the dividing walls.

11. The flat fluorescent lamp of claim 6, wherein two of the heat wires in the second region are disposed to partially overlap the each of the dividing walls.

12. The flat fluorescent lamp of claim 5, wherein one of the heat wires in each of the first and second regions is disposed to overlap the each of the dividing walls and two of the heat wires in the second region are respectively disposed near side ends of the heat wires.

13. The flat fluorescent lamp of claim 6, wherein one of the heat wires in each of the first, second and third regions is disposed to overlap the each of the dividing walls and two of the heat wires in the third region are respectively disposed near side ends of the heat wires.

14. The flat fluorescent lamp of claim 3, wherein respective temperatures of the channel portions are substantially equal to each other during operation.

15. The flat fluorescent lamp of claim 3, wherein the channel portion is formed in an arch shape, the dividing wall is formed along a first direction and the electrode is formed on an edge of the first and second light source substrates crossing the first direction, and further comprising phosphor layers respectively formed on opposite surfaces of the first and second light source substrates.

16. The flat fluorescent lamp of claim 3, wherein a reflection layer is formed on the second light source substrate.

17. The flat fluorescent lamp of claim 3, wherein the discharge space is filled with a discharge gas.

18. The flat fluorescent lamp of claim 17, wherein the discharge gas includes mercury.

19. The flat fluorescent lamp of claim 1, wherein the electrode includes an external electrode.

20. A display device comprising;
a panel assembly displaying images;
a flat fluorescent lamp supplying light to the panel assembly; and
a supporting member supporting the panel assembly and the flat fluorescent lamp, wherein the flat fluorescent lamp comprises:
a lamp body divided into a plurality of discharge spaces and generating light,
an electrode formed on both ends of the lamp body, and
a plurality of heat wires unequally disposed within the discharge spaces.

21. The display device of claim 20, wherein:
the lamp body comprises a first light source substrate and a second light, source substrate arranged opposite to each other and divided into a plurality of regions; and
the heat wires are disposed in each of the regions in different numbers.

22. The display device of claim 21, wherein:
the first light source substrate and the second light source substrate form a plurality of channel portions forming the discharge spaces and a plurality of dividing walls partitioning the channel portions; and
the heat wires are disposed to adjoin the dividing walls.

23. The display device of claim 22, wherein:
the plurality of regions are partitioned along an arrangement direction of the channel portions; and
the number of heat wires disposed to adjoin each of the dividing walls in the respective regions gradually increases in the arrangement direction of the channel portions.

24. The display device of claim 22, wherein:
the plurality of regions comprise a first region and a second region; and
the number of heat wires disposed to adjoin each of the dividing walls in the first region is one and the number of heat wires disposed to adjoin each of the dividing walls in the second region is at least two.

25. The display device of claim 22, wherein:
the plurality of the regions comprise a first region, a second region, and a third region; and
the number of heat wires disposed to adjoin each of the dividing walls in the first region is one, the number of heat wires disposed to adjoin each of the dividing walls in the second region is two and the number of heat wires disposed to adjoin each of the dividing walls in the third region is three.

26. The display device of claim 24, wherein one of the heat wires in each of the first and second regions is disposed to overlap the each of the dividing walls.

27. The display device of claim 25, wherein one of the heat wires in each of the first, second and third regions is disposed to overlap the each of the dividing walls.

28. The display device of claim 24, wherein two of the heat wires in the second region are disposed to partially overlap the each of the dividing walls.

29. The display device of claim 24, wherein one of the heat wires in the second region is disposed to overlap the each of the dividing walls.

30. The display device of claim 25, wherein two of the heat wires in the second region are disposed to partially overlap the each of the dividing walls.

31. The display device of claim 24, wherein one of the heat wires in each of the first, second and third regions is disposed to overlap the each of the dividing walls and two of the heat wires in the second region are respectively disposed near side ends of the heat wires.

32. The display device of claim 25 wherein one of the heat wires in each of the first, second and third regions is disposed to overlap the each of the dividing walls and two of the heat wires in the third region are respectively disposed near side ends of the heat wires.

33. The display device of claim 22, wherein respective temperatures of the channel portions are substantially equal to each other while the flat fluorescent lamp operates.

34. The display device of claim 22, wherein:
the channel portion is formed in an arch shape and the dividing wall is formed along one direction;
the electrode is formed on an edge of the first and second light source substrates crossing the one direction; and
the flat fluorescent lamp further comprises phosphor layers respectively formed on opposite surfaces of the first and second light source substrates.

35. The display device of claim 22, wherein a reflection layer is formed on the second light source substrate.

36. The display device of claim 22, wherein the discharge space is filled with a discharge gas including mercury.

37. The display device of claim 20, wherein the electrode includes an external electrode.

38. The display device of claim 20, further comprising a prism member and a diffusing member disposed between the flat fluorescent lamp and the panel assembly.

39. The display device of claim 20, wherein the panel assembly is a liquid crystal panel.
